(19) United States
(12) Patent Application Publication
(10) Pub. No.: US 2014/0071487 A1
(43) Pub. Date: Mar. 13, 2014

(54) WORK FLOW GENERATION APPARATUS, WORK FLOW GENERATION METHOD, AND PROGRAM

(71) Applicant: Canon Kabushiki Kaisha, Tokyo (JP)

(72) Inventor: Masaaki Sato, Yokohama-shi (JP)

(73) Assignee: Canon Kabushiki Kaisha, Tokyo (JP)

(21) Appl. No.: 14/021,568

(22) Filed: Sep. 9, 2013

(30) Foreign Application Priority Data
Sep. 13, 2012 (JP) 2012-201697

(51) Int. Cl. G06F 3/12

(52) U.S. Cl. CPC G06F 3/1296
USPC 358/1.15

(57) ABSTRACT

The present disclosure is directed to a work flow generation apparatus for generating a work flow including a plurality of steps, includes an identification unit configured to identify which of a device and a cloud each execution location of one or more processing steps constituting the processes is, a switching unit configured to switch an order of processes so that a plurality of processes execution location of which has been determined to be the cloud by the identification unit can be called up altogether, and a generation unit configured to generate the work flow by collecting the plurality of continuously arrayed processes execution location of which has been determined to be the cloud by the identification unit as a result of the switching by the switching unit.

### BACKGROUND OF THE INVENTION

1. Field of the Invention

The present invention relates to a work flow generation apparatus, a work flow generation method, and a program.

2. Description of the Related Art

There has been developed a multifunction apparatus as a multifunction machine that integrates functions of image forming apparatuses such as a printer, a copying machine, and a facsimile. For the purpose of simplifying user's work in an office by integrating a plurality of functions in the multifunction apparatus, there has been an increase in number of devices that can carry out a plurality of processing steps to be executed at the multifunction apparatus as one job.

A function for providing work is provided depending on the user's work. Thus, since various work forms are assumed, a combination of arbitrary processing steps (hereinbelow, a flow) can be provided. As a flow which can be processed by the multifunction apparatus, processing combining a scanning function, an image edit function of converting an image, and a function of transmitting data to an external system can be designated. For the flow, various functions provided by the multifunction apparatus can be combined. As functions to be provided, for example, there are an input function of a box document which reuses scan data, an edit function of preventing show-through of image data, an edit function of integrating image data pieces, and an image edit function of extracting a character from an image.

The multifunction apparatus sequentially executes a combination of processing steps described in the flow, and a created flow can be repeatedly executed. Similar processing results can be obtained because the flow can be reused. Thus, work efficiency can be generally improved.

Recently, a cloud technology (computing services storing and utilizing applications in Internet, hereinbelow, referred to as cloud) has been generally used. For example, there has been offered a technique for registering an edit function of processing an image as a service in a host computer and allowing an arbitrary multifunction apparatus to use cloud resources by calling up the service (as discussed in Japanese Patent Application Laid-Open No. 2005-352692).

The edit function, a document management service, and so on provided by the cloud is started to be provided at an arbitrary timing on a service providing side. The multifunction apparatus generally uses the cloud resources based on preferential use in order of usable services.

However, in the conventional technique, for example, when a flow using a plurality of edit functions is executed, only some of the edit functions are provided by the cloud. Consequently, an issue of wasteful processing such as transferring of intermediate data between the cloud and the multifunction apparatus is generated.

### SUMMARY OF THE INVENTION

The present invention is directed to removal of wasteful processing such as transferring of data about a work flow between a cloud and a device as much as possible.

According to an aspect of the present invention, a work flow generation apparatus for generating a work flow including a plurality of processes includes an identification unit configured to identify which of a device and a cloud each execution location of one or more processing steps constituting the process is, a switching unit configured to switch an order of processing steps so that a plurality of processing steps of which execution location is identified as the cloud by the identification unit is collectively called up, and a generation unit configured to generate the work flow by collecting the plurality of continuously arrayed processing steps of which execution location is identified as the cloud by the identification unit as a result of the switching by the switching unit.

According to the present invention, wasteful processing such as transferring of data about a work flow between the cloud and the device can be removed as much as possible.

Further features of the present invention will become apparent from the following description of exemplary embodiments with reference to the attached drawings.

### BRIEF DESCRIPTION OF THE DRAWINGS

FIG. 1 illustrates an example of a system configuration of a work flow system including a multifunction apparatus, a host computer, and the like.

FIG. 2 illustrates an example of a hardware configuration of the multifunction apparatus.

FIG. 3 illustrates an example of a hardware configuration of the host computer.

FIG. 4 illustrates an example of a software configuration of a flow generation apparatus and a cloud function management apparatus according to a first exemplary embodiment.

FIG. 5 illustrates an example of a table managed by a multifunction management unit.

FIG. 6 illustrates an example of tables managed by a processing sequence management unit.

FIG. 7 illustrates an example of tables managed by a cloud function management unit.

FIG. 8 (including FIGS. 8A and 8B) is a flowchart illustrating an example of flow generation processing.

FIG. 9 is a flowchart illustrating an example of cloud function obtaining processing according to the first exemplary embodiment.

FIG. 10 illustrates an example of a flow describing a combination executable in the multifunction apparatus.

FIG. 11 illustrates an example of a flow setting in which an execution location of each process is determined according to a conventional method.

FIG. 12 illustrates an example of a generated flow.

FIG. 13 illustrates an example of a software configuration of a flow generation apparatus and a cloud function management apparatus according to a second exemplary embodiment.

FIG. 14 is a flowchart illustrating an example of cloud function obtaining processing according to the second exemplary embodiment.

### DESCRIPTION OF THE EMBODIMENTS

Various exemplary embodiments, features, and aspects of the invention will be described in detail below with reference to the drawings.

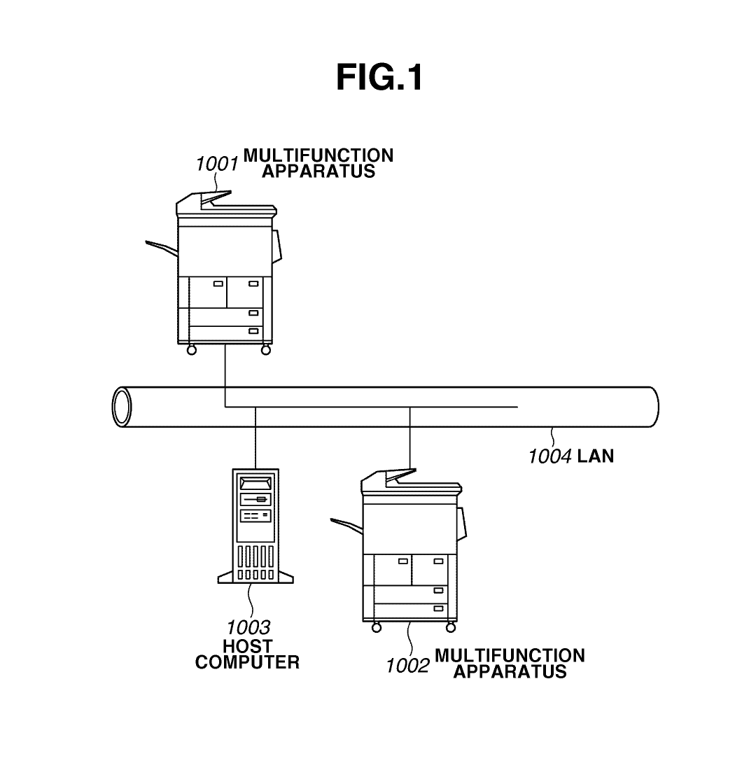

FIG. 1 illustrates an example of a system configuration of a work flow system including a multifunction apparatus, a host computer, and the like. The multifunction apparatus is a multifunction apparatus having a data transmission/reception function. The multifunction apparatus is an example of an image forming apparatus and a device.

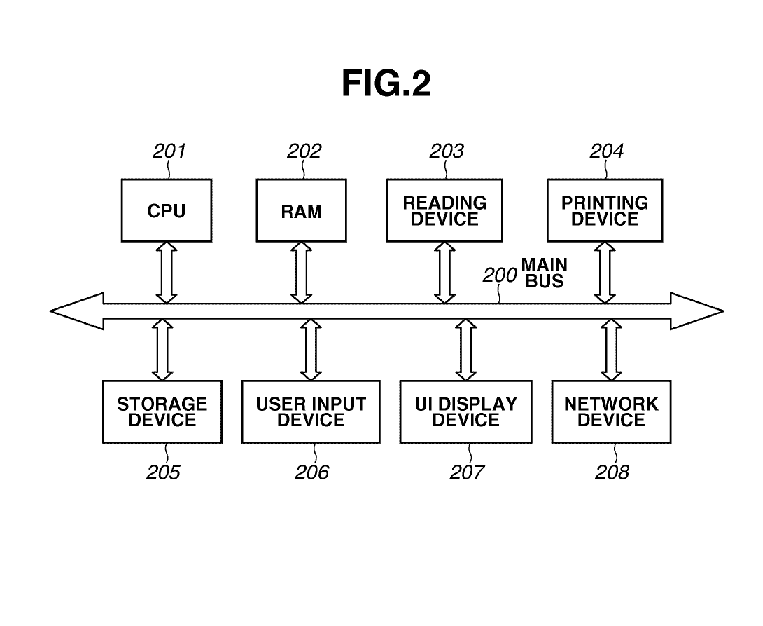

A multifunction apparatus 1001 is communicably connected to a host computer 1003, and a multifunction apparatus 1002 that provides a function equivalent to that of the host computer 1003. The multifunction apparatus 1001 has a copying function, a facsimile function, and a data transmission function of reading a document image and transmitting the read image to each device on a local area network (LAN) 1004. Further, the multifunction apparatus 1001 has a function of page description language (PDL) function, and accordingly can receive and print a PDL image instructed by a computer connected on the LAN 1004. The multifunction apparatus 1001 can store an image read by the multifunction apparatus 1001 or a PDL image instructed by the computer connected on the LAN 1004 in a designated box region such as a storage device 205 illustrated in FIG. 2 and described below in the multifunction apparatus 1001. The multifunction apparatus 1001 can print the image stored in the box region. Further, the multifunction apparatus 1001 combines processes of reading of a document image, editing (document integration, show-through removal, optical character recognition (OCR), and the like) of the image, and the data transmission function as a work flow, and registers a plurality of flows per user. The user can routinely perform processing by executing the flow registered in the multifunction apparatus 1001.

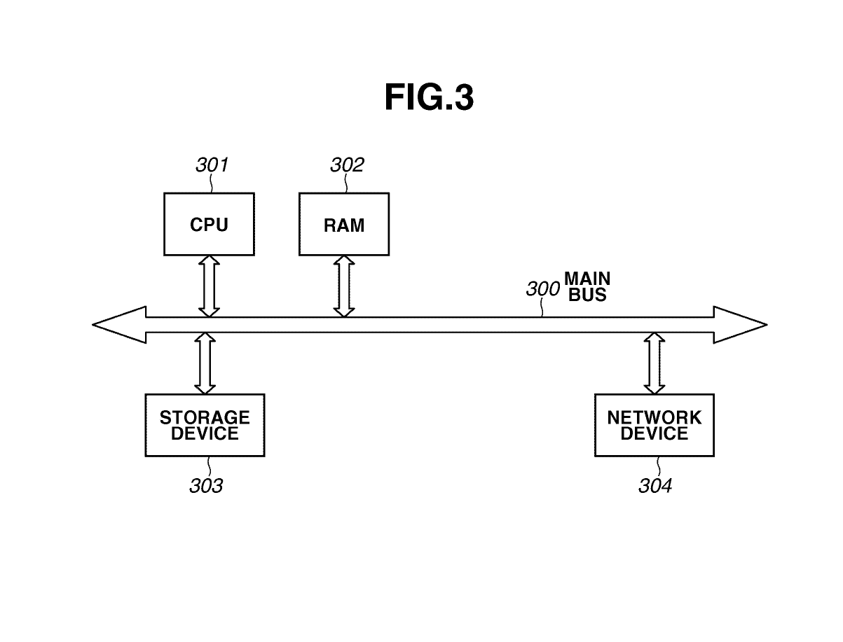

The host computer 1003 provides services usable via a network referred to as a cloud technology. Services to be provided include, for example, the image editing function and a document management function of managing received data. A central processing unit (CPU) 301 of the host computer 1003 illustrated in FIG. 3 described below provides the services by executing a program stored in a storage device 303 (similar to the storage device 205). The multifunction apparatus 1001 can use a function as a service by transmitting a request to the service provided by the host computer 1003 via the LAN 1004.

An application provided by the host computer 1003 can be stored in the storage device 205 in the multifunction apparatus 1002 to be provided. In other words, a CPU of the multifunction apparatus 1002 can provide the service by executing a program stored in the storage device of the multifunction apparatus 1002. In this case, the multifunction apparatus 1001 can use a function as a service by transmitting a request to the service provided by the multifunction apparatus 1002 via the LAN 1004.

FIG. 2 illustrates an example of a hardware configuration of the multifunction apparatuses 1001 and 1002. Each of the multifunction apparatuses 1001 and 1002 includes, as the hardware configuration, a CPU 201, a random access memory (RAM) 202, a reading device 203, a printing device 204, a storage device 205, a user input device 206, a user interface (UI) display device 207, and a network device 208. These hardware components are interconnected via a main bus 200.

The CPU 201 controls the entire multifunction apparatus. The RAM 202 provides a work area of the CPU 201. The reading device 203 reads an image. The printing device 204 prints an image. The storage device 205 stores a program or various pieces of setting information therein. An example of the storage device 205 is a hard disk or a nonvolatile RAM (NVRAM). The user input device 206 inputs user's command input to notify the CPU 201 of the input. The UI display device 207 displays a processing result of the CPU 201. The network device 208 performs communication with the other devices via the network. As in the case of a touch panel display, the UI display device 207 can also serve as the user input device 206.

When the CPU 201 executes processing based on the program stored in the storage device 205, a software configuration of the multifunction apparatus and processing of a flowchart described below are achieved. The software configuration of the multifunction apparatus is, for example, a functional configuration of a flow generation apparatus described below.

FIG. 3 illustrates an example of a hardware configuration of the host computer 1003. The host computer 1003 includes, as the hardware configuration, a CPU 301, a RAM 302, a reading device 303, and a network device 304. These hardware components are interconnected via a main bus 300.

The CPU 301 controls the entire host computer. The RAM 302 provides a work area of the CPU 301. The storage device 303 stores a program or various pieces of setting information. The network device 304 performs communication with the other devices via the network.

When the CPU 301 executes processing based on the program stored in the storage device 303, a software configuration or the like of the host computer 1003 described below is achieved. The software configuration of the host computer 1003 is, for example, a functional configuration of a cloud function management apparatus described below.

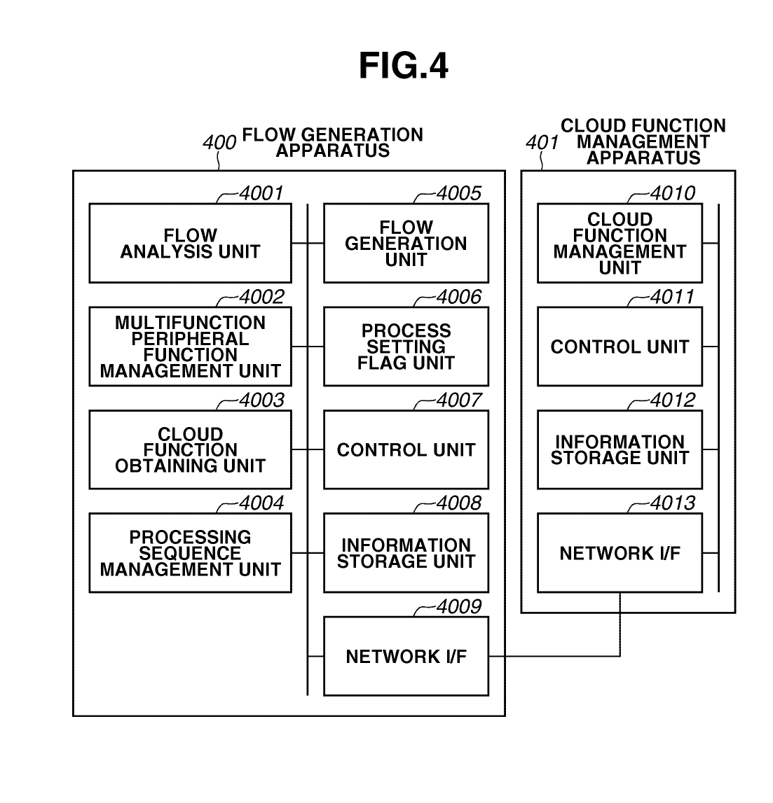

FIG. 4 illustrates an example of a software configuration of a flow generation apparatus 400 and a cloud function management apparatus 401 according to a first exemplary embodiment. The flow generation apparatus 400 is an example of a work flow generation apparatus.

The flow generation apparatus 400 is an example of a device that provides a function realized by the CPU 201 of the multifunction apparatus 1001 executing processing based on the program stored in the storage device 205. The cloud function management 401 is an example of a device that provides a function realized by the CPU 301 of the host computer 1003 executing processing based on the program stored in the storage device 303.

The flow generation apparatus 400 checks a process in a specified flow, and sets a process integrating cloud processing, thereby generating a flow executable by the multifunction apparatus 1001 and the host computer 1003. Thus, the flow generation apparatus 400 can remove wasteful transferring of intermediate data between the multifunction apparatus 1001 and the host computer 1003.

A flow analysis unit 4001 analyzes contents of the specified flow, and sequentially reads analysis results in order of processes.

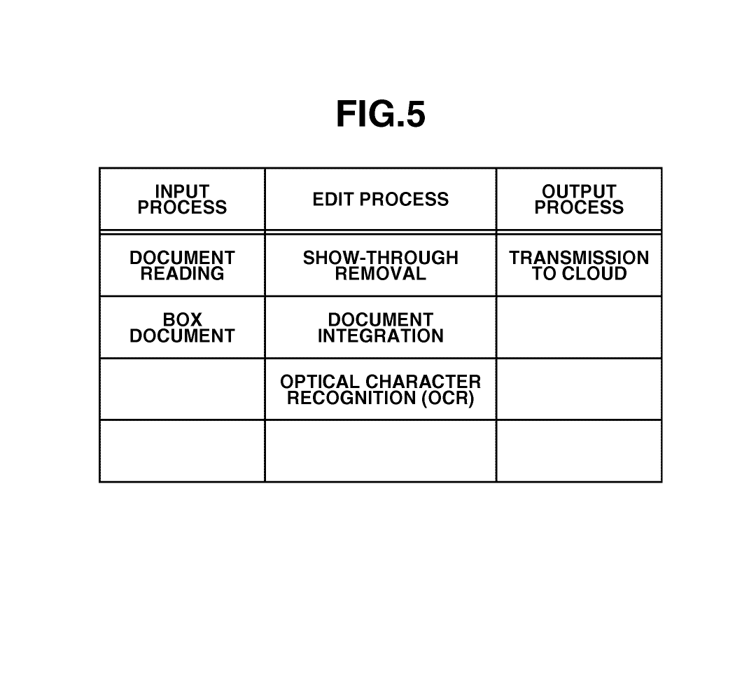

A multifunction peripheral function management unit 4002 manages functions provided by the multifunction apparatus 1001. FIG. 5 described below illustrates an example of a table managed by the multifunction peripheral function management unit 4002.

A cloud function obtaining unit 4003 uses the cloud function management apparatus 401 to obtain functional services provided by the host computer 1003.

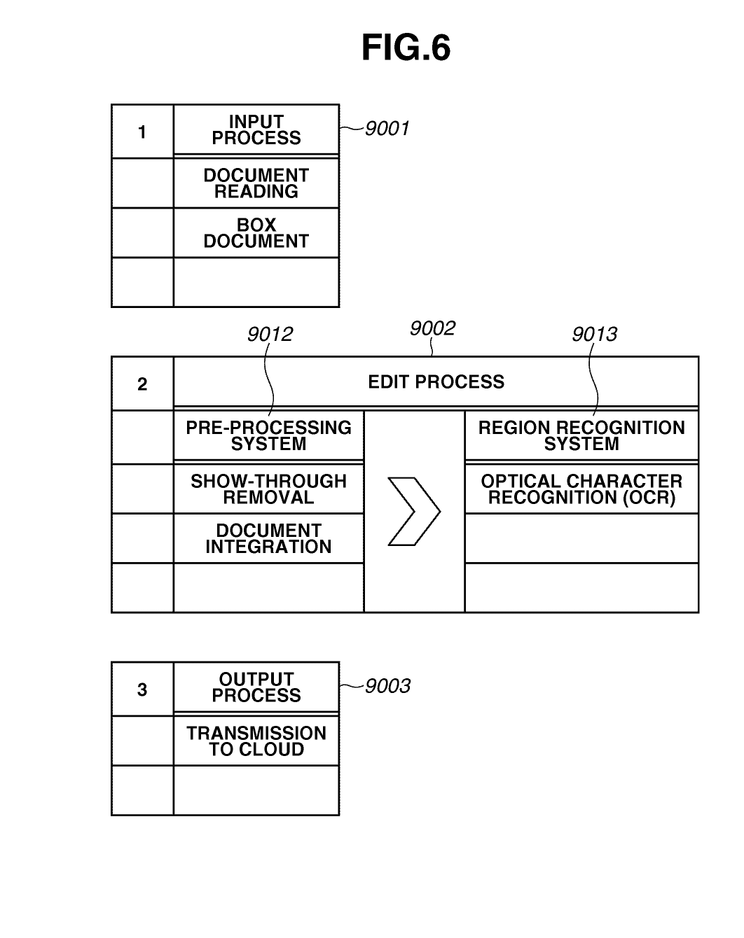

A processing sequence management unit 4004 manages a processing sequence of processing constituting processes described in the flow. FIG. 6 described below illustrates an example of tables managed by the processing sequence management unit 4004.

A flow generation unit 4005 generates a flow executable by the multifunction apparatus 1001.

A process setting flag unit 4006 sets a flag indicating which of an input process side and an output process side an edit process to be executed by the cloud is preferentially set to.

The cloud function management apparatus 401 manages the functional services provided by the host computer 1003, and provides functions usable as cloud services.

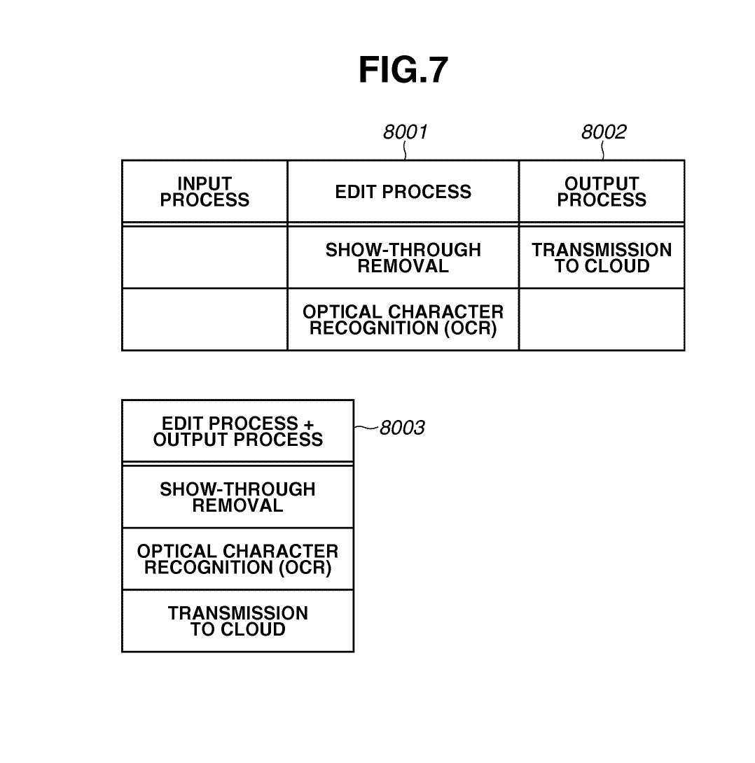

A cloud function management unit 4010 manages the functions provided by the host computer 1003. FIG. 7 described below illustrates an example of tables managed by the cloud function management unit 4010.

Control units 4007 and 4011 are modules for controlling management of various functions or processing the functions such as calling.

Information storage units (H/D) 4008 and 4012 are modules for storing necessary information in the storage devices 205 and 303 and obtaining the stored information based on the control of the control units 4007 and 4011.

Network interfaces (I/F) 4009 and 4013 are modules for communicating with the other devices by the network via the network devices 208 and 304.

FIG. 5 illustrates the example of the table managed by the multifunction peripheral function management unit 4002. For example, the multifunction peripheral function management unit 4002 manages a plurality of functions executable in each process of the multifunction apparatus 1001 by the table.

FIG. 6 illustrates the example of the tables managed by the processing sequence management unit 4004. For example, the processing sequence management unit 4004 manages processing sequences for the respective processes by the tables. A sequence of an input process 9001, an edit process 9002, and an output process 9003 is unchangeable. Thus, in the example illustrated in FIG. 6, the processes are managed such that the input process is number 1, the edit process is number 2, and the output process is number 3.

In the example illustrated in FIG. 6, a pre-processing system 9012 and a region recognition system 9013 in the edit process 9002 are unchangeable in order as a group, and thus they are indicated by an arrow. In the example illustrated in FIG. 6, any of a plurality of processing steps (show-through removal and document integration) in the preprocessing system 9012 can be performed first.

FIG. 7 illustrates the example of the tables managed by the cloud function management unit 4010. For example, the cloud function management unit 4010 manages a plurality of functions executable for each process in the host computer 1003 by the table. An edit process 8001 and an output process 8002 indicate processes usable by single functions. An edit process+output process 8003 indicates processes usable by a combination of functions.

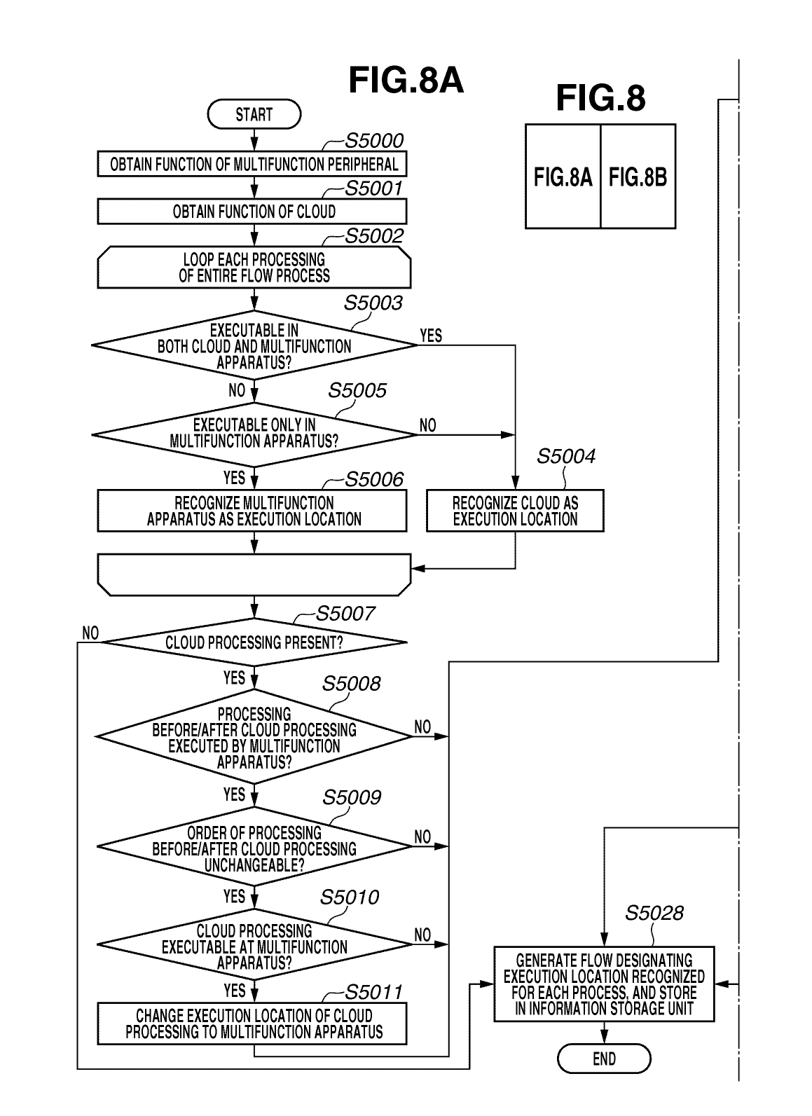

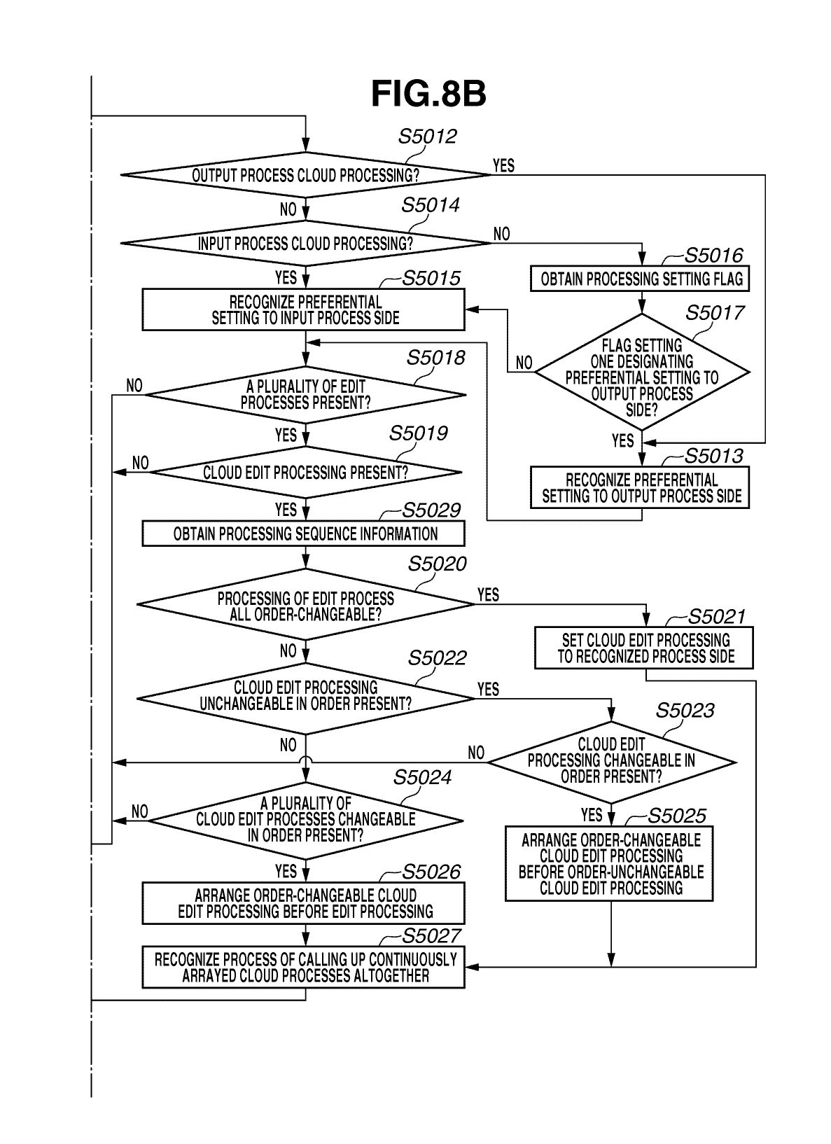

FIG. 8 (including FIGS. 8A and 8B) is a flowchart illustrating an example of flow generation processing.

In step S5000, the control unit 4007 calls up the multifunction peripheral function management unit 4002 to obtain functions provided by the multifunction peripheral, and stores information about the obtained functions in a temporary storage region (the information storage unit 4008).

In step S5001, the control unit 4007 calls up the cloud function obtaining unit 4003 to obtain functions provided by the cloud, and stores information about the obtained functions in the temporary storage region. The processing of obtaining the cloud functions by calling up the cloud function obtaining unit 4003 will be described below in cloud function obtaining processing.

In step S5002, the control unit 4007 calls up the flow analysis unit 4001 to read an analysis result of a flow to be performed, starts loop processing of each processing step of all the processes in the flow of the analysis result, and performs processing described below while specifying each processing step in the process. In other words, the control unit 4007 identifies which of a device and a cloud each execution location of one or more processing steps constituting the process is in the loop processing in step S5002.

In step S5003, the control unit 4007 determines whether specified processing can be executed by both of the host computer 1003 and the multifunction apparatus 1001 based on a content of the processing, the function provided by the multifunction peripheral, and the cloud function. If the control 4007 determines that the processing can be executed by both (YES in step S5003), the processing proceeds to step S5004. Otherwise (NO in step S5003), the processing proceeds to step S5005.

In step S5004, the control unit 4007 recognizes an execution location of the specified processing as the cloud, and stores information about the processing (which processing in which process) and the execution location (i.e., the cloud) in the temporary storage region.

In step S5005, the control unit 4007 determines whether the specified processing is executable only in the multifunction apparatus 1001 based on the content of the processing, the function provided by the multifunction peripheral, and the cloud function. When the control 4007 determines that the specified processing is executable only at the multifunction apparatus 1001 (YES in step S5005), the processing proceeds to step S5006. Whereas if the specified processing is executable in other than the multifunction apparatus 1001 (NO in step S5005), the processing proceeds to step S5004.

In step S5006, the control unit 4007 recognizes an execution location of the specified processing as the multifunction apparatus 1001, and stores information about the processing (which processing in which process) and the execution location (i.e., the multifunction apparatus) in the temporary storage region.

In step S5007, the control unit 4007 determines whether processing of which execution location is the cloud is present based on the information stored in step S5004 or

S5006. When the control unit 4007 determines that there is a target to be processed by the cloud (YES in step S5007), the processing proceeds to step S5008. Otherwise (NO in step S5007), the processing proceeds to step S5028.

In step S5008, the control unit 4007 determines whether processing before/after the processing of which execution location is the cloud is processing executed in the multifunction apparatus 1001 based on the information stored in step S5004 or 55006. When the control unit 4007 determines that the processing before/after the processing of which execution location is the cloud is processing executed in the multifunction apparatus 1001 (YES in step S5008), the processing proceeds to step S5009. Otherwise (NO in step S5008), the processing proceeds to step S5012.

In step S5009, the control unit 4007 determines whether the order of the processing before/after the processing of which execution location is the cloud is unchangeable based on the information of the processing sequence management unit 4004. When the control unit 4007 determines that the order of the processing before/after the processing of which execution location is the cloud is unchangeable (YES in step S5009), the processing proceeds to step S5010. Otherwise (NO in step S5009), the processing proceeds to step S5012.

In step S5010, the control unit 4007 determines whether processing of which execution location is the cloud is processing which can be executed in the multifunction apparatus 1001 based on a content of the processing of which execution location is the cloud and a function provided by the multifunction peripheral. When the control unit 4007 determines that the processing of which execution location is the cloud is processing executable in the multifunction apparatus 1001 (YES in step S5010), the processing proceeds to step S5011. Otherwise (NO in step S5010), the processing proceeds to step S5012

In step S5011, the control unit 4007 changes the execution location of the processing of which execution location is the cloud to the multifunction apparatus 1001. The control unit 4007 stores information about the processing of which execution location has been changed and the execution location of the processing (i.e., information indicating the multifunction apparatus 1001) in the temporary storage region.

In step S5012, the control unit 4007 determines whether all the processing steps in the output process are processing executed by the cloud based on the information stored in step S5004, S5006, or S5011. When the control unit 4007 determines that all the processing steps in the output process are executed by the cloud (YES in step S5012), the processing proceeds to step S5013. Otherwise (NO in step S5012), the processing proceeds to step S5014.

In step S5013, the control unit 4007 recognizes that processing executed by the cloud in the edit process is preferentially set to the output process side (subsequent process side, i.e., after the edit process), and stores the recognition result in the temporary storage region.

In step S5014, the control unit 4007 determines whether all the processing steps in the input process are processing executed by the cloud based on the information stored in step S5004, S5006, or S5011. When the control unit 4007 determines that all the processing steps in the input process are processing executed by the cloud (YES in step S5014), the processing proceeds to step S5015. Otherwise (NO in step S5014), the processing proceeds to step S5016.

In step S5015, the control unit 4007 recognizes that the processing executed by the cloud in the edit process is preferentially set to the input process side (previous process side, i.e., before the edit process), and stores the recognition result in the temporary storage region.

In step S5016, the control unit 4007 calls up the process setting flag unit 4006 to obtain a setting flag in which information about which of the input process side and the output process side the edit process executed by the cloud is set to is set.

When the control unit 4007 determines that the setting flag obtained in step S5016 indicates the preferential setting to the output process side (YES in step S5017), the processing proceeds to step S5013. Otherwise (NO in step S5017), the processing proceeds to step S5015.

In step S5018, the control unit 4007 determines whether a plurality of processing steps is present in the edit process of the work flow. When the control unit 4007 determines that a plurality of processing steps is present in the edit process of the work flow (YES in step S5018), the processing proceeds to step S5019. Otherwise (NO in step S5018), the processing proceeds to step S5028.

In step S5019, the control unit 4007 determines whether edit processing executed by the cloud (i.e., cloud edit processing) is present in the edit process of the work flow. When the control unit 4007 determines that the cloud edit processing is present in the edit process of the work flow (YES in step S5019), the processing proceeds to step S5029. Otherwise (NO in step S5019), the processing proceeds to step S5028.

In step S5029, the control unit 4007 calls up the processing sequence management unit 4004 to store information about each processing order of the processes described in the obtained flow in the temporary storage unit.

In step S5020, the control unit 4007 determines whether the order of all the processing steps in the edit process is changeable based on the obtained order information. When the control unit 4007 determines that the order of all the processing steps in the edit process is changeable (YES in step S5020), the processing proceeds to step S5021. Otherwise (NO in step S5020), the processing proceeds to step S5022.

In step S5021, the control unit 4007 stores information indicating that processing executed by the cloud in the edit process of which order can be changed is arrayed to be set to the process side set by the setting flag in the temporary storage region.

In step S5022, the control unit 4007 determines whether the edit process includes cloud edit processing unchangeable in order based on the obtained order information. When the control unit 4007 determines that the edit process includes the cloud edit processing unchangeable in order (YES in step S5022), the processing proceeds to step S5023. Otherwise (NO in step S5022), the processing proceeds to step S5024.

In step S5023, the control unit 4007 determines whether the edit process includes cloud edit processing changeable in order based on the obtained order information. When the control unit 4007 determines that the edit process includes the cloud edit processing changeable in order (YES in step S5023), the processing proceeds to step S5025. Otherwise (NO in step S5023), the processing proceeds to step S5028.

In step S5024, the control unit 4007 determines whether the edit process includes a plurality (i.e., two or more) of cloud edit processing steps changeable in order based on the obtained order information. When the control unit 4007 determines that the edit process includes a plurality of cloud edit processing steps changeable in order (YES in step S5024), the processing proceeds to step S5026. Otherwise (NO in step S5024), the processing proceeds to step S5028.

In step S5025, the control unit 4007 stores information indicating that the cloud edit processing changeable in order is arranged before the cloud edit processing unchangeable in order in the temporary storage region.

In step S5026, the control unit 4007 stores information indicating that the edit processing of which execution location is the cloud and changeable in order is arranged before the edit process in the temporary storage region.

In step S5027, the control unit 4007 stores information indicating that the processing steps of which execution location is the cloud and which are continuously arrayed are set as a process to be collectively called up in the temporary storage region.

In step S5028, the control unit 4007 designates, based on the information stored in the temporary storage region, an execution location of each processing constituting the process, and calls up the flow generation unit 4005 to generate a flow, and stores the generated flow in the information storage unit (H/D) 4008.

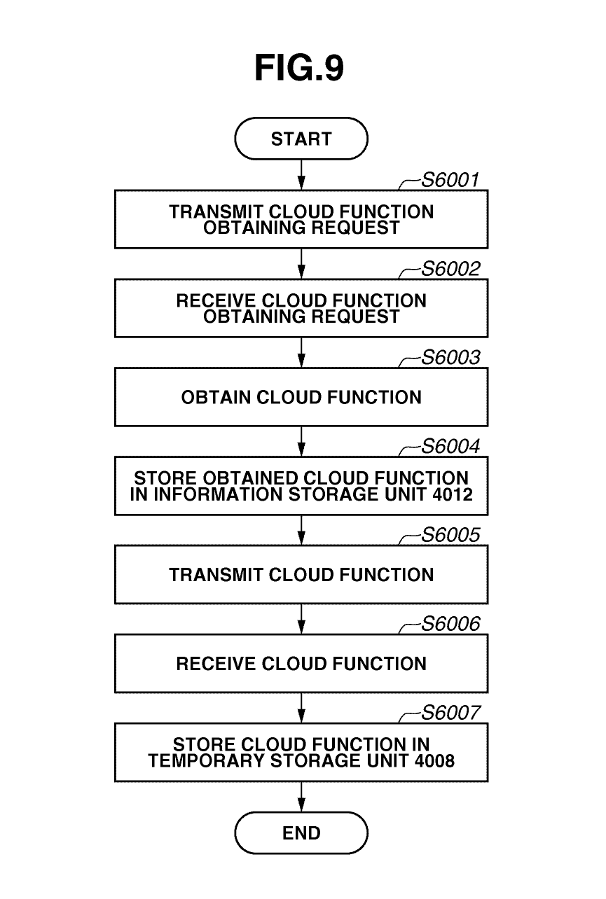

FIG. 9 is a flowchart illustrating an example of cloud function obtaining processing according to the first exemplary embodiment.

In step S6001, the control unit 4007 calls up the cloud function obtaining unit 4003, and transmits a request of obtaining a cloud function to the cloud function management apparatus 401 via the network I/F 4009.

In step S6002, the control unit 4011 receives the request of obtaining the cloud function via the network I/F 4013.

In step S6003, the control unit 4011 obtains a cloud function managed by the cloud function management unit 4010 based on the received request of obtaining the cloud function.

In step S6004, the control unit 4011 stores the obtained cloud function in the information storage unit 4012.

In step S6005, the control unit 4011 transmits the obtained cloud function to the flow generation apparatus 400 via the network I/F 4013.

In step S6006, the control unit 4007 transmits the received cloud function to the cloud function obtaining unit 4003 via the network I/F 4009.

In step S6007, the control unit 4007 calls up the cloud function obtaining unit 4003, and stores the obtained function provided by the cloud in the temporary storage region.

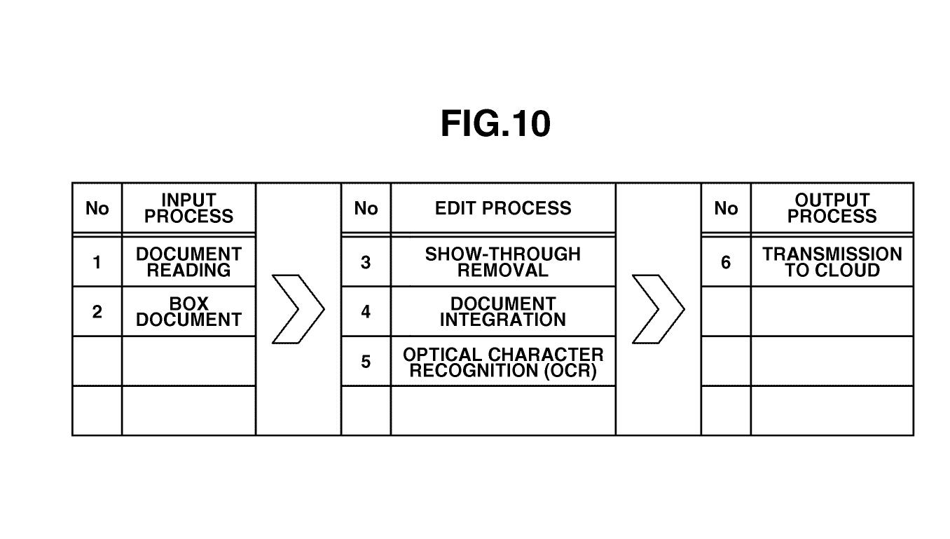

With reference to FIGS. 10 to 12, an example including an issue that wasteful intermediate data is generated by applying a cloud function to a flow to be executed according to a conventional method, and a result of applying the present exemplary embodiment will be described.

FIG. 10 illustrates an example of a flow describing a combination executable in the multifunction apparatus 1001. Hereinbelow, the flow will be referred to as an original flow.

In the original flow, a combination of processing steps described below is sequentially performed.

### [Input Process]

No. 1 Document reading
No. 2 Box document

### [Edit Process]

No. 3 Show-through removal
No. 4 Document integration
No. 5 Optical character recognition (hereinbelow, OCR)

### [Output Process]

No. 6 Transmission to cloud

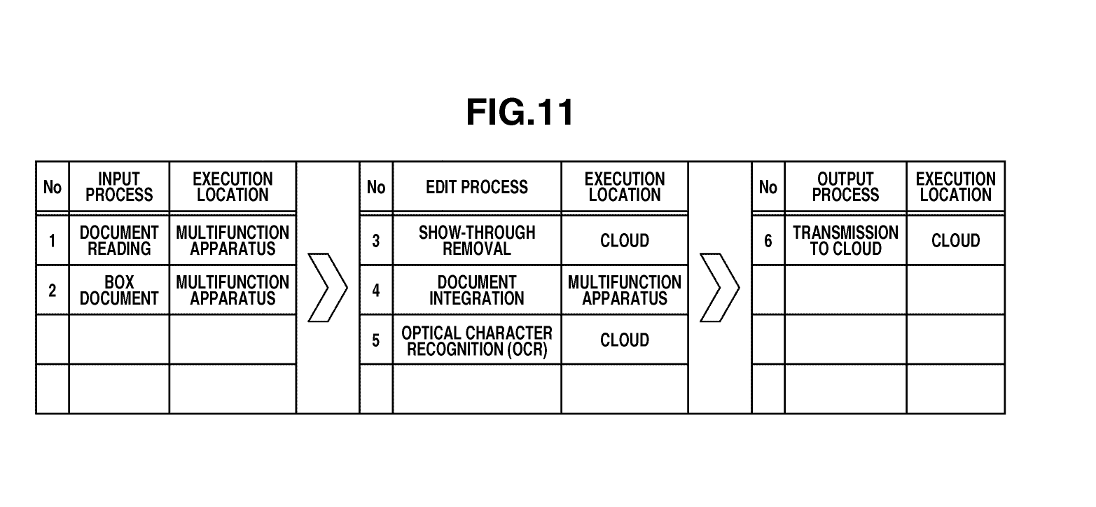

FIG. 11 illustrates an example of a flow setting in which an execution location of each process is determined according to the conventional method. Conventionally, the multifunction apparatus 1001 preferentially uses services usable in the host computer 1003. Thus, services usable for each process are executed by the cloud. Functions usable by the cloud are functions of the respective processing steps illustrated in FIG. 7, and accordingly, No. 3, No. 5, and No. 6 are targets to be executed by the cloud.

When the processing steps in the flow are sequentially performed, since the document integration of No. 4 is executed in the multifunction apparatus 1001, a waste of transmitting intermediate data (data in the middle of processing) of a processing result of No. 3 from the cloud to the multifunction apparatus 1001 is generated. In addition, since the transmission to cloud of No. 6 is performed, a waste of transmitting intermediate data of a processing result of No. 5 from the host computer 1003 to the multifunction apparatus 1001 is generated.

Next, a result of applying the present exemplary embodiment to the original flow will be described.

After execution of the original flow has been recognized, the processing proceeds to steps S5000 to S5003.

In step S5004, the control unit 4007 identifies processing steps of No. 3, No. 5, and No. 6 as the processing of which execution location is the cloud.

In steps S5005 and S5006, the control unit 4007 identifies processing steps of No. 1, No. 2, and No. 4 as the processing of which execution location is the multifunction apparatus 1001.

Then the processing proceeds through steps S5007, S5008, and S5009, and the processing of No. 4 is the processing in the edit process changeable in order in the multifunction apparatus 1001. Thus, the control unit 4007 advances the processing to step S5012.

In step S5012, since the execution location of the processing of No. 6 is the cloud, the control unit 4007 advances the processing to step S5013, and sets the processing of No.6 to be arranged on the output process side. After the arrangement on the output process side has been set, the control unit 4007 advances the processing to steps S5018 (the edit process includes a plurality of processing steps), step S5019 (the edit process includes processing executed by the cloud), and step S5029, and recognizes order information of the processing steps in the process.

Then the processing proceeds through steps S5020 (all processing steps in the edit process are not changeable in order) and S5022, since OCR (No. 5) that is the cloud processing unchangeable in order is present, the control unit 4007 advances the processing to step S5023.

In step S5023, since the processing (No. 3) that is the cloud edit processing changeable in order is present (YES in step S5023), the control unit 4007 advances the processing to step S5025.

In step S5025, the control unit 4007 sets the cloud edit processing changeable in order (No. 3) before the cloud edit processing unchangeable in order (No. 5), and proceeds to step S5027.

In step S5027, the control unit 4007 sets a process in which continuously arrayed cloud processing steps (show-through removal+OCR+transmission to cloud) are collected, and proceeds to step S5028.

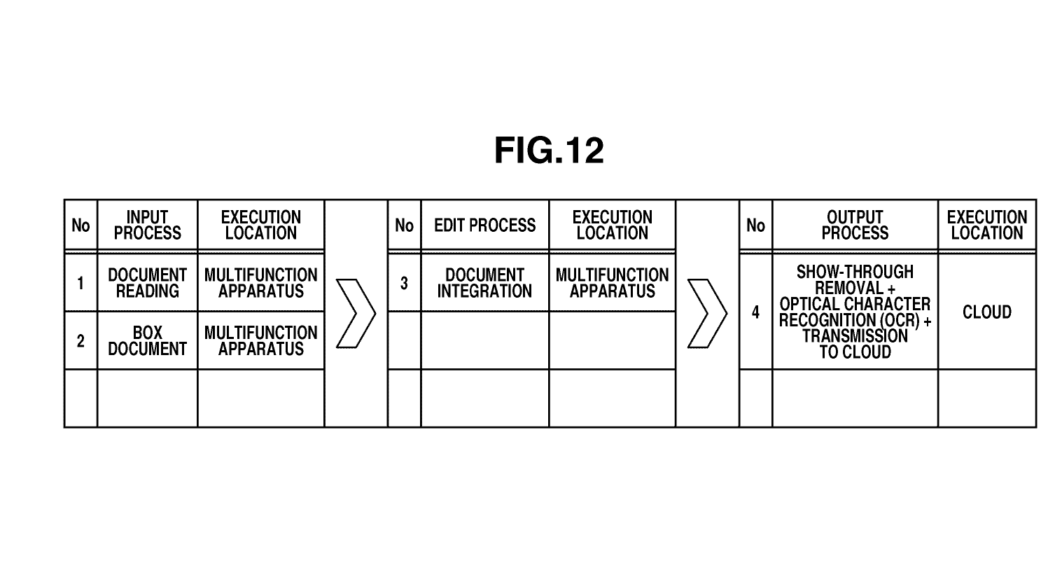

In step S5028, the control unit 4007 generates a flow designating a set (or recognized) execution location. FIG. 12 illustrates an example of a generated flow.

When the flow (FIG. 12) generated based on the application result is executed, the collective processing, No. 4 [show-through removal+OCR+transmission to cloud] is only executed by the cloud.

As a result, a waste of transmitting intermediate data from the host computer 1003 to the multifunction apparatus 1001 can be removed, and user convenience can be improved.

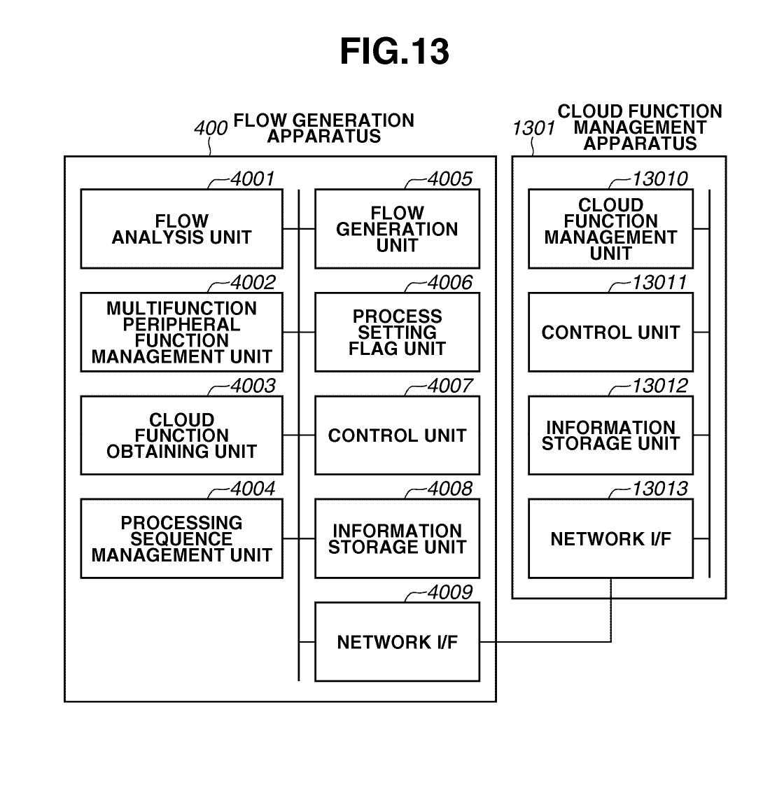

FIG. 13 illustrates an example of a software configuration of a flow generation apparatus 400 and a cloud function management apparatus 1301 according to a second exemplary embodiment. A difference from the first exemplary embodiment is that an apparatus (host computer 1003) for providing cloud functions is provided by a multifunction apparatus 1002. Hereinbelow, the difference from the first exemplary embodiment will be mainly described.

The cloud function management apparatus 1301 is an example of a device which provides functions realized by executing processing based on a program stored in a storage device 205 by a CPU 201 of the multifunction apparatus 1002.

A cloud function management unit 13010 manages functions provided as cloud services by the multifunction apparatus 1002.

A control unit 13011 is a module for controlling processing of each function such as management or calling of various functions.

An information storage unit (H/D) 13012 is a module for storing necessary information in the storage device 205 and obtaining the stored information based on the control of the control unit 13011.

A network interface (I/F) 13013 is a module for communicating with the other devices by the network via the network device 208.

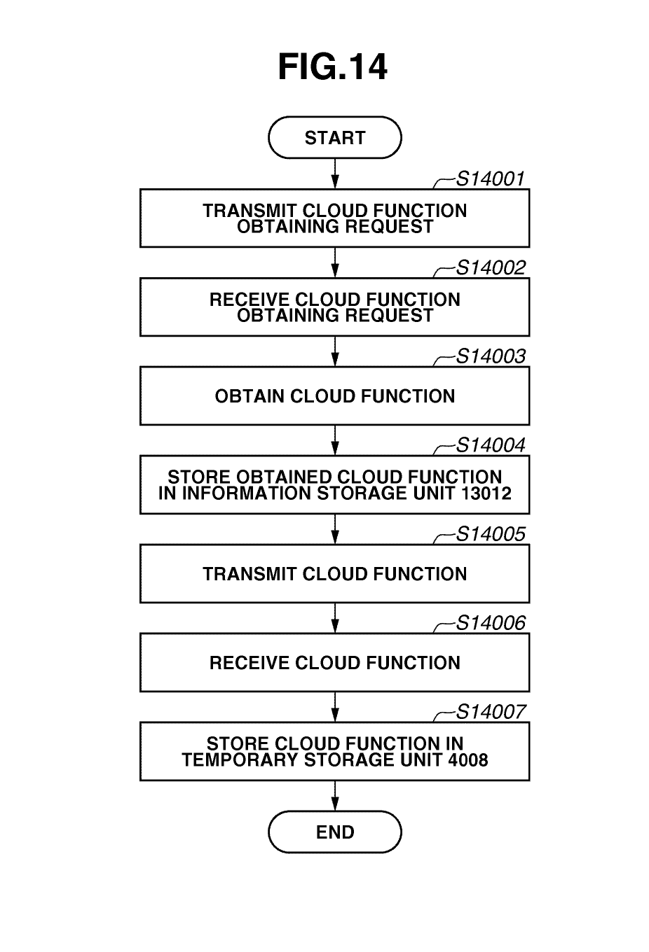

FIG. 14 is a flowchart illustrating an example of cloud function obtaining processing according to the second exemplary embodiment.

In step S14001, the control unit 4007 calls up the cloud function obtaining unit 4003, and transmits a request of obtaining a cloud function to the cloud function management apparatus 1301 via the network I/F 4009.

In step S14002, the control unit 13011 receives the request of obtaining the cloud function via the network I/F 13013.

In step S14003, the control unit 13011 obtains a cloud function managed by the cloud function management unit 13010 based on the received request of obtaining the cloud function.

In step S14004, the control unit 13011 stores the obtained cloud function in the information storage unit 13012.

In step S14005, the control unit 13011 transmits the obtained cloud function to the flow generation apparatus 400 via the network I/F 13013.

In step S14006, the control unit 4007 transmits the received cloud function to the cloud function obtaining unit 4003 via the network I/F 4009.

In step S14007, the control unit 4007 calls up the cloud function obtaining unit 4003, and stores the obtained function provided by the cloud in the temporary storage region.

By applying the present exemplary embodiment, the processing steps of the cloud can be collectively performed. Thus, a waste of transmitting intermediate data from the multifunction apparatus 1002 to the multifunction apparatus 1001 can be removed, and user convenience can be improved.

According to the above-described exemplary embodiments, the processing steps of the cloud can be collectively performed. Thus, a waste of transmitting intermediate data from the cloud to the multifunction apparatus can be removed, and user convenience can be improved.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiments of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), a micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-201697 filed Sep. 13, 2012, which is hereby incorporated by reference herein in its entirety.

What is claimed is:

1. A work flow generation apparatus for generating a work flow including a plurality of processes, the work flow generation apparatus comprising:
an identification unit configured to identify which of a device and a cloud each execution location of one or more processing steps constituting the process is;
a switching unit configured to switch an order of processing steps so that a plurality of processing steps of which execution location is identified as the cloud by the identification unit is collectively called up; and
a generation unit configured to generate the work flow by collecting the plurality of continuously arrayed processing steps of which execution location is identified as the cloud by the identification unit as a result of the switching by the switching unit.

2. The work flow generation apparatus according to claim 1, wherein the identification unit identifies which of the device and the cloud each execution location of one or more processing steps constituting the process is based on contents of one or more processing steps constituting the process, a function of the device, and a function of the cloud.

3. The work flow generation apparatus according to claim 2, wherein the identification unit identifies the execution location of the processing step as the cloud in a case where the processing step is determined to be executable by both of the device and the cloud based on the contents of the processing steps, the function of the device, and the function of the cloud.

4. The work flow generation apparatus according to claim 1, wherein the plurality of processes includes an input process, an edit process, and an output process, and
wherein, in a case where the identification unit identifies that an execution location of a processing step in the input process is the device, an execution location of a processing step in the output process is the cloud, and an execution location of one or more processing steps changeable in order among the plurality of processing steps included the edit process is the cloud, the switching unit switches an order of processing such that the one or more processing steps changeable in the order are set to processing in the output process.

5. The work flow generation apparatus according to claim 1, wherein the plurality of processes includes an input process, an edit process, and an output process, and
wherein, in a case where the identification unit identifies that an execution location of a processing step in the input process is the cloud, an execution location of a processing step in the output process is the device, and an execution location of one or more processing steps changeable in order among the plurality of processing steps included the edit process is the cloud, the switching unit switches an order of processing such that the one or more processing steps changeable in the order are set to processing in the input process.

6. The work flow generation apparatus according to claim 1, wherein, in a case where the identification unit identifies that an execution location of one or more processing steps changeable in order among the plurality of processing steps constituting the process is the cloud, and an execution location of one or more processing steps unchangeable in order is the cloud, the switching unit switches an order of processing such that the one or more processing steps changeable in the order are set to processing of the one or more processing steps unchangeable in order.

7. The work flow generation apparatus according to claim 1, wherein, in a case where the identification unit identifies that an execution location of two or more processing steps changeable in order among the plurality of processing steps constituting the process is the cloud, and an execution location of one or more processing steps unchangeable in order is the device, the switching unit switches an order of processing such that the two or more processing steps changeable in the order before the process.

8. The work flow generation apparatus according to claim 1, further comprising a setting unit configured to, in a case where the switching unit switches processing steps, set whether to switch an order of the processing steps to before the process or to after the process,
wherein the switching unit switches the order of the processing steps to be set before or after the process so that a plurality of processing steps of which execution location is identified as the cloud by the identification unit can be collectively called up according to the setting by the setting unit.

9. The work flow generation apparatus according to claim 1, wherein the device is an image forming apparatus capable of providing a plurality of functions of executing at least one or more processing steps constituting the process.

10. The work flow generation apparatus according to claim 1, wherein the work flow generation apparatus is an image forming apparatus capable of providing a plurality of functions of executing at least one or more processing steps constituting the process.

11. The work flow generation apparatus according to claim 1, wherein the cloud is a service provided by another work flow generation apparatus communicable via a network.

12. A method for generating a work flow executed by a work flow generation apparatus for generating a work flow including a plurality of processes, the method comprising:
identifying which of a device and a cloud each execution location of one or more processing steps constituting the process is;
switching an order of processing steps so that a plurality of processing steps of which execution location is identified as the cloud is collectively called up; and
generating the work flow by collecting the plurality of continuously arrayed processing steps of which execution location is identified as the cloud as a result of the switching.

13. A program causing a computer for generating a work flow including a plurality of processes to execute:
identifying which of a device and a cloud each execution location of one or more processing steps constituting the process is;
switching an order of processing steps so that a plurality of processing steps of which execution location is identified as the cloud is collectively called up; and
generating the work flow by collecting the plurality of continuously arrayed processing steps of which execution location is identified as the cloud as a result of the switching.
